(19) United States
(12) Patent Application Publication
(10) Pub. No.: US 2007/0268580 A1
(43) Pub. Date: Nov. 22, 2007

(54) Display Device

(75) Inventors: Alexander Biebel, Bickenbach (DE); Andreas Baldus, Zornheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT AG, 55122 Mainz (DE)

(21) Appl. No.: 10/581,938

(22) PCT Filed: Dec. 16, 2004
(86) PCT No.: PCT/EP04/14357

§ 371 Date: Mar. 13, 2007

(30) Foreign Application Priority Data
Dec. 16, 2003 (DE) 103 59 156.7

(51) Int. Cl. G02B 27/22

(52) U.S. Cl. 359/479

(57) ABSTRACT

A display device is provided that includes a luminous element and a laterally structured luminous surface. The laterally structured luminous surface has at least one region that is capable of illumination, as well as at least two light-reflecting layers that are spaced apart from one another and between which light emitted by the luminous surface is reflected back and forth. At least one of the two light-reflecting layers are semitransparent, and at least one of the two light-reflecting layers is arranged at a distance from the luminous element.

The invention relates in general terms to a display device, in particular a display device which gives a sense of optical depth to the content displayed.

Conventional display elements generally display their information in two-dimensional form on a display surface. By way of example, it is known to use OLED display elements (OLED=organic light-emitting diode) which have a structured luminous surface and impart their information to an observer in the form of regions which light up and regions which do not light up or are dark. However, there is in general terms a demand for further technical options for allowing information to be presented more effectively and creatively. One such option consists, for example, in imparting a sense of optical depth, and therefore particular optical attraction, to the information displayed, which is inherently two-dimensional.

WO 03/075369 has disclosed an electronic display device with a polymer LED display which has a semitransparent reflecting layer. However, reflection at the single reflection layer does not create a sense of optical depth.

The invention is based on the object of providing a display device in which a sense of optical depth is imparted to the information displayed.

This object is achieved in a surprisingly simple way by the luminous element as described in claim 1. Advantageous configurations and refinements form the subject-matter of the subclaims.

Accordingly, a display device according to the invention comprises a luminous element and a laterally structured luminous surface having at least one region that is capable of illumination, as well as at least two light-reflecting layers or reflection layers, which are spaced apart from one another and between which light emitted by the luminous surface is reflected back and forth, at least one of the light-reflecting layers being arranged at a distance from the luminous element. To release light from the display device for display purposes, moreover, at least one of the light-reflecting layers is semitransparent.

In particular, it is also possible for both light-reflecting layers to be at a distance from the luminous element. It is then also advantageous if both layers are semitransparent, in order to allow both the input of light from the luminous element and the emergence of light on the side of the observer.

In the context of the present invention, a light-reflecting layer is preferably to be understood as meaning a layer with a reflectivity of at least 10%, particularly preferably of at least 50% in the visible region. In particular, the semitransparent layer may have a reflectivity in the range from 10% to 90%.

The light which is emitted from the luminous element when the display device is operating is reflected to and fro between the light-reflecting layers; on each reflection at the semitransparent light-reflecting layer, part of the light passes out through the layer on the observation side and can be seen by the observer. If the luminous surface is observed at a non-perpendicular angle with parallel light-reflecting layers, images of the luminous structures of the laterally structured luminous surface which have been reflected different numbers of times appear at different depths below the image which has passed directly to the observer through the semitransparent layer. This creates an apparent sense of depth or a three-dimensional impression on the part of the luminous structures of the luminous surface.

The virtual distance between the reflected images and therefore their impression of depth is in this case determined by the distance between the reflecting layers. Accordingly, the distance between the layers is preferably in each case selected as a function of the use and the sense of depth to be achieved, and also as a function of the size of the structures of the luminous surface. The distance between the layers is typically preferably at least 100 micrometers, for preference at least 500 micrometers, particularly preferably at least 1 millimeter.

A preferred arrangement of two light-reflecting layers which are spaced apart from one another can be realized in a simple way by a transparent substrate which has two light-reflecting layers on opposite sides, the substrate being arranged with one of these sides opposite the luminous surface of the display device or parallel to the luminous surface. In particular, one of the sides with a light-reflecting layer of the substrate can be placed onto the luminous element or a substrate which supports the luminous element. Preferred materials for the substrate are ceramics, glass-ceramics, glass, vitreous substances or plastics.

If at least one of the light-reflecting layers is arranged displaceably relative to the other layer, it is possible to alter the sense of depth by varying the distance between the two light-reflecting layers and to configure this sense of depth freely according to the shape of said layer.

An arrangement of this type made up of at least two light-reflecting layers which are variably spaced apart from one another can be realized in a simple way by a light-reflecting layer which is applied to a transparent support substrate which is arranged such that it can be displaced or positioned with respect to a first light-reflecting layer. The support substrate may, for example, comprise a polymer film, a glass pane or a glass sheet.

An embodiment of the invention provides for at least one of the reflecting layers to comprise an interference reflection layer. A layer of this type generally comprises a plurality of successive individual layers with a refractive index which alternates between two values from individual layer to individual layer, or with alternating layers with a high refractive index and a low refractive index. By way of example, individual layers which alternately contain niobium oxide, tantalum oxide or titanium oxide for layers with a high refractive index and aluminum oxide, hafnium oxide, silicon oxide or magnesium fluoride for layers with a low refractive index, are suitable for this purpose. Other suitable coating materials for interference layers are known to a person skilled in the art.

Interference reflection layers of this type are relatively insensitive to ageing and, as semitransparent layers, can be adapted to the wavelength region emitted by the luminous element.

However, at least one of the reflective layers may also comprise a metallic reflection layer. Reflection layers of this type are particularly simple to produce, since only a single metallic layer has to be applied.

According to a particularly preferred embodiment of the invention, the luminous element comprises an OLED.

OLEDs can readily be produced in a very flat form with a large surface area. It is also easy to realize laterally structured luminous surfaces.

Moreover, OLEDs can already be produced with very good internal quantum efficiencies (number of photons per injected electron). For example, OLED layer structures with internal quantum efficiencies of 85% are already known.

In simplified terms, OLEDs are generally composed of two electrode layers with different work functions, between which is arranged an active layer comprising organic electroluminescent material. Moreover, one of the electrode layers is at least partially transparent, in order to allow the light generated in the active layer to emerge. Transparent conductive metal oxides (TCO: transparent conductive oxides), in particular indium tin oxide (ITO), or thin semitransparent metal layers or combinations thereof are preferably used to form the partially transparent electrode.

OLEDs as luminous elements are also recommended on account of the fact that in general one of the electrode layers between which the active layer is arranged reflects light. Then, according to one embodiment of the invention, an electrode layer of this type of the OLED may simultaneously form one of the light-reflecting layers of the display device according to the invention.

The reflectance of the partially transparent electrode may also be configured in such a way, by suitable measures, that according to one embodiment of the invention this electrode simultaneously forms one of the light-reflecting layers of the display device according to the invention. For this purpose it is possible, for example, for an electrode layer of the OLED to comprise a layer comprising transparent conductive oxide (TCO), in particular indium tin oxide, and a semitransparent thin metal layer and to form one of the light-reflecting layers. In this case, the spectral reflection properties of the layer combination of this electrode layer are substantially determined by the choice of metal and the respective layer thicknesses of metal layer and TCO layer. Precious metals, in particular platinum or gold, which with work functions of greater than 4 eV are sufficiently well matched to the potential demands of the OLED layers, are particularly suitable. Double-layer electrode layers for an OLED comprising a transparent conductive oxide layer and a metal layer are also known from U.S. Pat. No. 6,262,441 B1 and EP 966 050. Of course, a multilayer electrode layer of the OLED of this type can also be used without forming one of the light-reflecting layers of the display device according to the invention.

An OLED with structured luminous surface may, for example, have a laterally structured insulation layer which is arranged between the two electrode layers of the OLED luminous element and covers at least a region of one of the electrode layers. In this way, the flow of current is interrupted in a region covered by the insulation layer, so that the luminous surface remains dark in this region. Accordingly, the luminous surface, when voltage is applied to the electrode layers, lights up in an uncovered region, since the flow of current is not impeded here.

To limit the flow of current and therefore the emission of light to local regions of the luminous surface, it is also possible for at least one of the electrode layers to be laterally structured. For this purpose, this layer can be deposited directly in structured form, for example by means of shadowmask techniques using vacuum coating processes, or alternatively may be deposited as a continuous layer which is subsequently structured or patterned, for example by etching processes.

Another way of creating a structured luminous surface consists in blending out parts of the light emitted by the luminous element in regions. For this purpose, the display device may, for example, have a laterally structured mask. Combinations of these structuring methods and measures for creating a structured luminous surface are also feasible.

According to a further embodiment of the invention, the light-reflecting layers are arranged parallel to one another. In this case, the apparent sense of optical depth occurs in particular if the observer views the luminous surface obliquely. The impression of depth created by the arrangement can be made adjustable by means of a variable distance between the light-reflecting layers.

However, it is also possible for the light-reflecting layers to be arranged obliquely with respect to one another. The sense of optical depth becomes visible here even if the observer is looking at the luminous surface at right angles. In addition, the individual reflection images are tilted at a fixed angle, which results from the inclination of the light-reflecting layers, with respect to one another, which brings about a curvature of the sense of optical depth.

Further optical effects can also be achieved, for example, by at least one of the light-reflecting layers being curved.

It is also possible for a partially absorbing material, in particular a colored material, to be arranged in the beam path between the reflection layers. It is in this way possible to influence the color sensation, with the color of the light gradually changing from reflection to reflection given a suitable choice of the material. This results in individual reflection images which are apparent at different heights for the observer and each have a different hue.

A similar effect can also be achieved by the at least one semitransparent light-reflecting layer having a transmittance or reflectance which varies spectrally in the wavelength region of the light emitted by the luminous element and/or as a function of the angle of incidence.

The impression of depth can be boosted and further modeled by the addition of further semitransparent reflecting layers. Accordingly, the display device according to the invention may also have three or more light-reflecting layers spaced apart from one another.

Furthermore, with an arrangement of this type having three or more light-reflecting layers, it is possible for two or more of these layers to be arranged parallel, obliquely or curved with respect to one another, which boosts or modulates the impression of depth. Moreover, the layers may have different transmittances or reflectances.

In a preferred, simple refinement of an embodiment of the invention with three or more light-reflecting layers, at least one additional substrate having at least one semitransparent reflection coating or a semitransparent light-reflecting layer may be applied to the basic embodiment of the invention with two light-reflecting layers.

A display device according to the invention can be used in a wide variety of ways. By way of example, consideration is given to using a display device of this type as an information display means of a

motor vehicle, or

a telecommunications device, such as for example a mobile telephone, or

a domestic appliance, such as in particular a white goods appliance, for example a kitchen appliance, or a brown goods appliance (domestic appliance used outside the kitchen, such as for example for heating, electricity supply, gas supply or water supply), or

a toy, or

an advertising, warning or information board, or

an emblem or logo.

The invention is explained in more detail below on the basis of exemplary embodiments and with reference to the accompanying drawings, in which identical reference designations relate to identical or similar parts.

In the drawing:

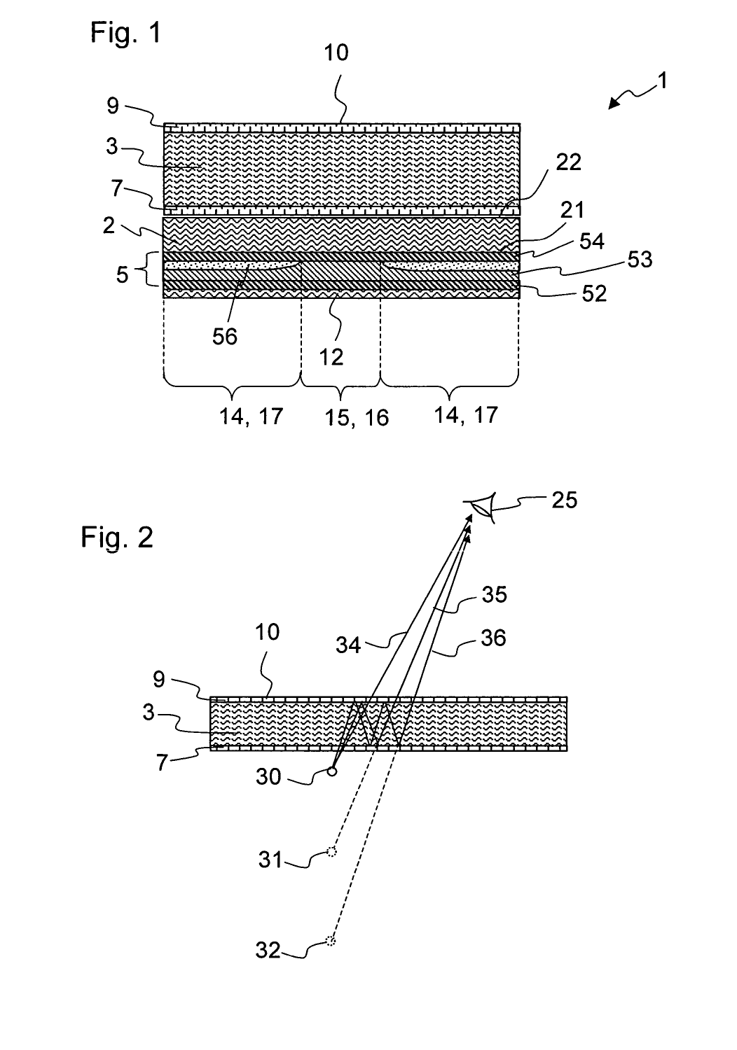

FIG. 1 shows a first embodiment of the invention,

FIG. 2 shows a sketch of the beam path of light for the embodiment shown in FIG. 1,

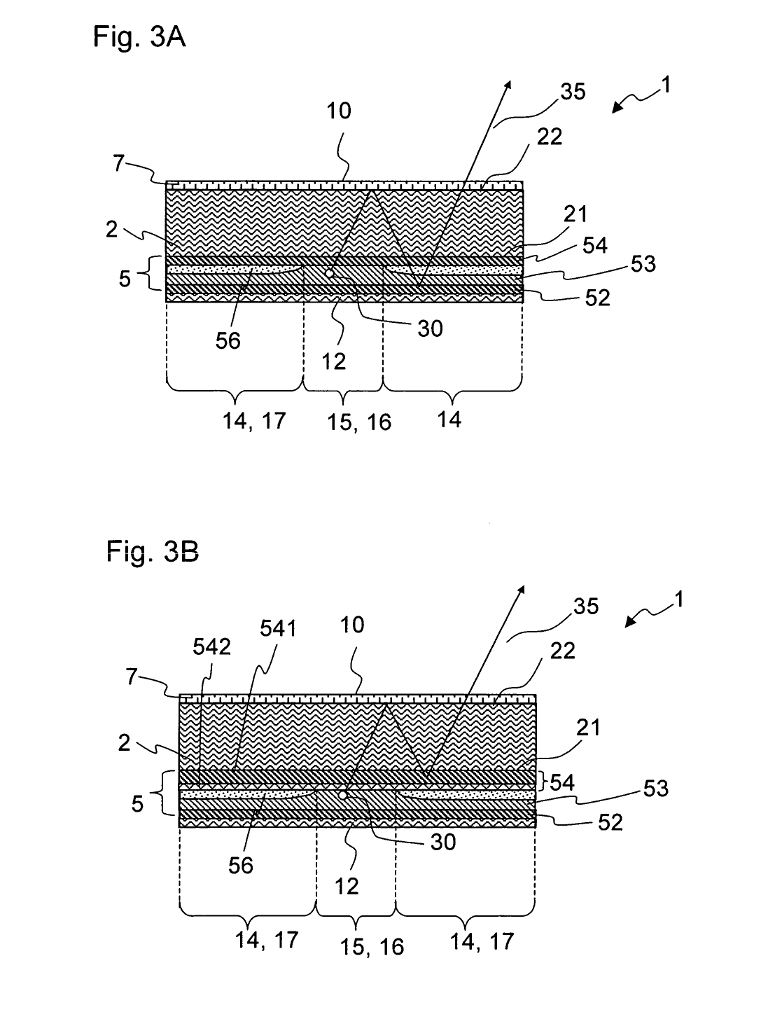

FIGS. 3A and 3B show further embodiments of the invention, in which one of the electrode layers of the OLED forms one of the light-reflecting layers,

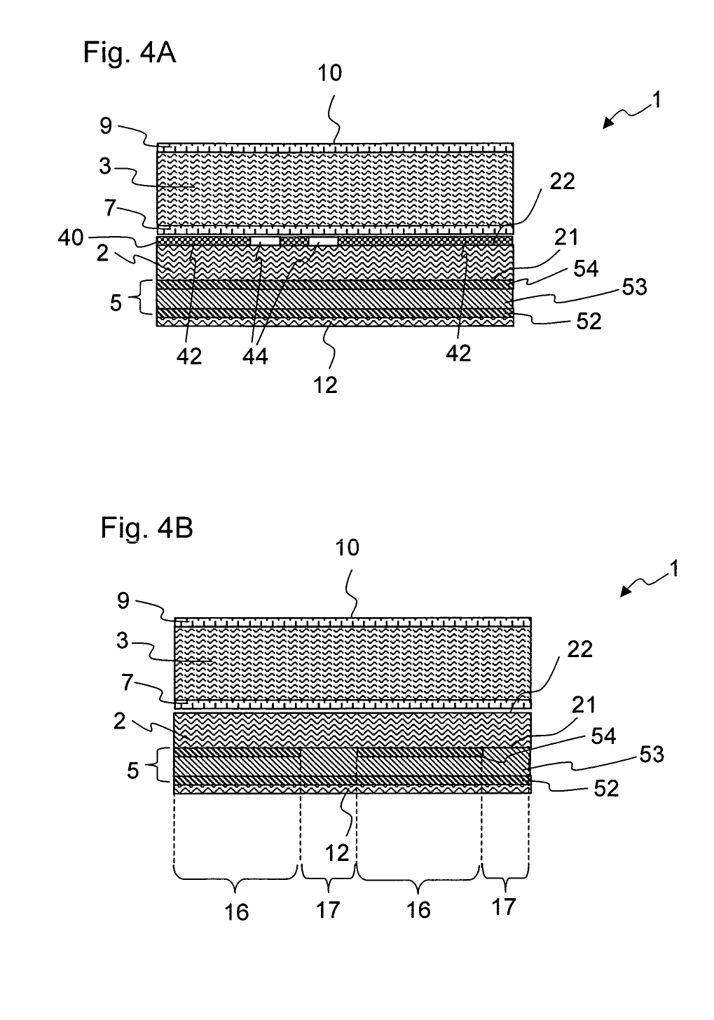

FIGS. 4A and 4B show variants of the embodiment illustrated in FIG. 1,

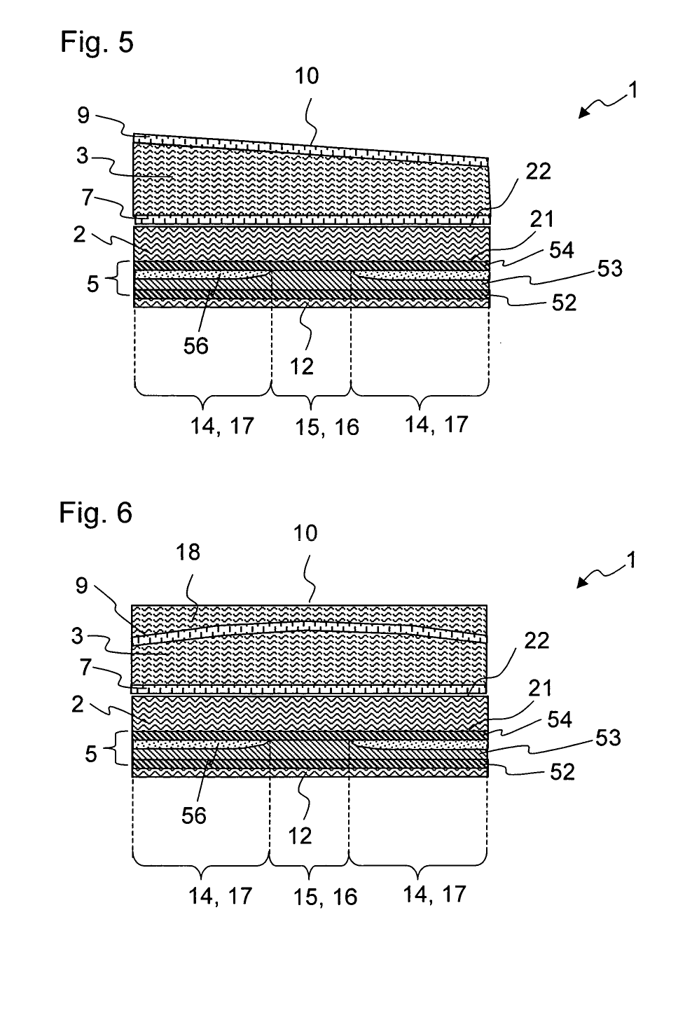

FIG. 5 shows an embodiment of the invention with light-reflecting layers arranged obliquely with respect to one another,

FIG. 6 shows an exemplary embodiment of a display device according to the invention with a curved light-reflecting layer,

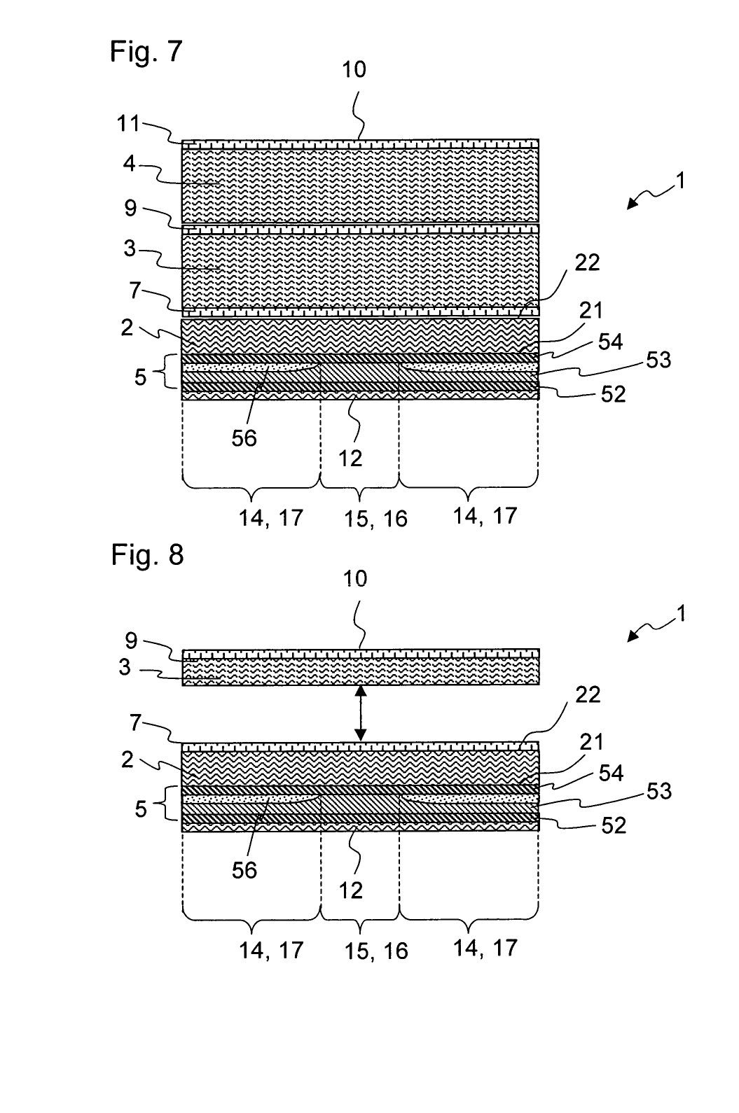

FIG. 7 shows an embodiment of the invention with three light-reflecting layers, and

FIG. 8 shows an embodiment with a distance which can be set variably between the light-reflecting layers.

FIG. 1 illustrates a diagrammatic sectional view through a first embodiment of a display device according to the invention, which is denoted overall by reference numeral 1.

As luminous element, the display device 1 has an OLED, which is denoted overall by 5, in the form of a layer structure or layer sequence. The layer structure of the OLED 5 has been applied to one side 21 of a transparent substrate 2 which serves as a support for the OLED 5.

Layers 52 and 54 are electrode layers for supplying voltage to the electroluminescent layer 53 arranged between these layers. The electrode layer 54 which is in contact with the substrate 2 is in this case designed as a light-transmitting electrode layer, so that light which is emitted by the electroluminescent layer 53 can pass through the electrode layer 54 into the transparent substrate 2. Recommended materials for the electrode layer 54 are in particular transparent conductive oxides (TCO), such as for example indium tin oxide (ITO) or another conductive and at least partially transparent material, e.g. thin, sufficiently transparent metal layers.

On account of a difference in work function between the electrode layers 52 and 54, given a correct polarity of the voltage applied to the layers 52 and 54, electrons are injected into unoccupied electronic states of the organic electroluminescent material at the layer acting as cathode. At the same time, the layer acting as anode with a lower work function injects defect electrons or holes, with the result that light quanta are emitted in the organic material through recombination of the electrons with the defect electrons.

The structure, composition and sequence of the OLED layers is known to a person skilled in the art. Of course, any OLED layer structure known from the prior art can be used for the invention.

By way of example, the electroluminescent layers used may be layers which include MEH-PPV ((poly(2-methoxy, 5-(2′-ethylhexyloxy)paraphenylenevinylene) or alternatively Alq₃ (tris(8-hydroxyquinolino)aluminum) as organic, electroluminescent material. Nowadays, a large number of suitable electroluminescent materials, such as for example metalorganic complexes, in particular triplet emitters or lanthanide complexes, are known. Layers and materials of this type, as well as various possible layer sequences within organic, electro-optical elements, such as in particular OLEDs, are described, for example, in the following documents as well as the literature references included therein, which are hereby in this respect entirely incorporated by reference in the present application:

1. Nature, Vol. 405, pages 661-664,

2. Adv. Mater. 2000, 12, No. 4, pages 265-269,

3. EP 0573549,

4. U.S. Pat. No. 6,107,452.

Moreover, better quantum yields can be achieved with an OLED if, in addition to the active electroluminescent layer 53, further functional layers are also arranged between the electrode layers 52, 54. By way of example, at least one potential matching layer, an electron blocking layer, a hole blocking layer and/or an electron conductor layer, a hole conductor layer, and/or an electron and/or hole injection layer may additionally be present in the OLED 5 as further functional layers between the two layers 52, 54. The function, arrangement and composition of these functional layers are known from the specialist literature.

To create a structured luminous surface of the OLED 5 or the display device 1, moreover, a laterally structured insulation layer 56 is arranged between the two electrode layers 52, 54. This insulation layer covers regions 14 of the electrode layer 54 while leaving clear one or more other regions 15. On account of the presence of the insulation layer on the covered regions, the flow of current between the electrode layers is interrupted there. Accordingly, a flow of current and therefore an electroluminescence of the active layer 53 takes place only along the regions 15. These regions form regions 16 of the luminous surface which light up, while the covered regions 14 form regions 17 of the luminous surface which do not light up. This creates a luminous surface of the OLED 5 which is laterally structured with respect to the observer. In this embodiment of the invention, the luminous surface, for the observer, runs parallel to the observation side 10 along the active electroluminescent layer 53 of the OLED 5.

To ensure that the layers of the OLED 5 are protected from environmental influences, a covering 12 is also applied to the OLED 5. The covering 12 may, for example, comprise a glass covering in the form of an attached glass plate and/or an evaporation-coating glass layer. In general terms, glass is very suitable for the encapsulation of OLEDs, since it has a particularly high barrier action with respect to reactive constituents of the atmosphere, such as oxygen and water, and thereby counteracts degradation of the OLED layers. Other forms of covering or encapsulation are also known to a person skilled in the art.

A further transparent substrate 3 serves as support for two light-reflecting layers 7, 9, which, spaced apart from one another, are applied to opposite sides of the substrate 3 and are arranged at a distance from the luminous element, in this case the OLED 5. As can be seen from FIG. 1, the sides of the substrate, and therefore also the two semitransparent light-reflecting layers, are also arranged parallel to one another in this embodiment.

The substrate 3 is placed, by way of the side having the light-reflecting layer 7, onto the substrate having the OLED 5, opposite the luminous surface of the OLED 5, so that the other light-reflecting layer 9 is arranged on the side 10 of the observer of the display device 1. Another way of arranging two light-reflecting layers at a distance from one another, as an alternative to the embodiment shown in FIG. 1, consists in applying the layer 7 to the substrate 2, in which case the substrate 3 then has only one light-reflecting layer 9.

In the embodiment of a display device 1 according to the invention illustrated in FIG. 1, both light-reflecting layers 7, 9 are semitransparent for the light emitted by the OLED 5. Semitransparent light-reflecting layers of this type may, for example, comprise interference reflection layers. An interference reflection layer may, for example, comprise a sequence of layers with a low refractive index containing aluminum oxide, hafnium oxide, silicon oxide or magnesium fluoride and layers with a high refractive index containing niobium oxide, tantalum oxide or titanium oxide. A layer comprising 20 to 40 individual layers has proven suitable as a wide-band semitransparent reflection layer, but even smaller numbers of individual layers are also sufficient to achieve the optical effect.

Interference layers of this type can also be produced in a simple way by multiple dip coating in suitable dip-coating baths. Further preferred production techniques include vacuum coating (PVD), such as thermal evaporation or sputtering, chemical vapor deposition (CVD) processes, such as thermal, plasma (PECVD) or microwave pulse induced (PICVD) layer formation.

However, it is also possible to use very thin metallic reflection layers which are still partially transparent to the light on account of their low thickness.

The optical effect which this arrangement gives for an observer is explained in more detail with reference to FIG. 2. FIG. 2 once again illustrates the substrate 3 with the two semitransparent, light-reflecting layers 7, 9. An emission point 30 of the electroluminescent layer 53 is additionally illustrated. The further parts of the display device are not illustrated, for the sake of clarity.

Starting from the emission point, by way of example three light beams which emerge at different angles are illustrated; these light beams reach the eye of an observer. In the process, the light beam 34 passes through the transparent substrate 3 with the semitransparent layers 7, 9 without being reflected and reaches the eye of the observer. The light beam 35 is reflected to and fro once at the two light-reflecting layers 7, 9 before emerging from the display device. Finally, the light beam 36 is reflected to and fro twice between the light-reflecting layers 7, 9.

The light beams 35 and 36 reveal that the arrangement with the two light-reflecting layers 7, 9 arranged at a distance from one another enables light beams which emerge from the emission point 30 at different angles to reach the eye 25 of an observer. However, a light beam which has been reflected between the light-reflecting layers and reaches the eye 25 at a different angle than a beam transmitted directly appears to the observer to originate from a virtual emission point which is arranged in a plane that does not coincide with the luminous surface. More specifically, in the arrangement shown in FIG. 1 or 2, the virtual emission points appear to the observer to lie below the true emission point 30. The virtual emission points for the light beams 35 and 36 are denoted by 31 and 32, respectively. To ensure that this effect manifests itself to the observer, it is expedient for the observer to look at the luminous surface of the display device 1 at an oblique angle.

It can also be seen from FIG. 2 that only certain, discrete emission angles of light beams each allow a beam path which reaches the eye in its instantaneous position. Therefore, the virtual emission points or virtual images of the luminous surface appear to the observer at discrete distances below the luminous surface comprising the true emission point 30. The position of the virtual images of the luminous surface is in particular also dependent on the distance between the reflection layers 7, 9. Greater distances between the reflection layers 7, 9 also lead to greater apparent vertical distances between the individual virtual images and from the true picture of the luminous surface.

However, the refraction of the light beams at the interfaces between different media, in particular when a light beam emerges from the substrate 3, have not been taken into account in the above considerations and in FIG. 2. The refraction affects, inter alia, the position of the virtual emission points 31, 32 and therefore the position of the virtual images of the luminous surface.

If at least one of the semitransparent light-reflecting layers also has a spectrally varying transmittance in the wavelength region of the light emitted by the luminous element, it is possible to achieve an additional aesthetic color effect, since the spectral distribution of the light which reaches the observer changes as a function of the number of reflections between the light-reflecting layers. Each reflection also transmits a certain proportion of the light intensity, with the spectral distribution of the reflected beam also being influenced by the spectrally selective transmission.

It is also possible for at least one of the semitransparent light-reflecting layers 7, 9 to have a transmittance which varies spectrally as a function of the angle of incidence of a light beam. This can be realized, for example, with an interference reflection layer. Since each of the virtual emission points can be assigned a specific discrete reflection angle, in a refinement of the invention of this nature, it is even possible for the light of each of the virtual emission points to have a different spectral distribution. Therefore, the virtual images of the luminous surface and the true picture of the luminous surface each appear in a different hue. Since the optical path length also changes with the number of reflections between the layers, a similar effect can also be achieved by a partially absorbing material, in particular a colored material, being arranged between the reflection layers 7, 9. By way of example, a suitably colored substrate 3 can be used for this purpose.

FIG. 3A shows a further embodiment of a display device 1 according to the invention. In this embodiment of the invention, the electrode layer 52 of the OLED 5 itself forms one of the light-reflecting layers, the light-reflecting layer 7 being arranged at a distance from the luminous element 5. A semitransparent layer 7 has been applied direct to the substrate 2 which supports the OLED 5. The beam path is very similar to that shown in FIG. 2. However, in the exemplary embodiment shown in FIG. 3A, the emission point 30 in the electroluminescent layer 53 is located not outside but rather between the light-reflecting layers 7 and 53. A beam path 35 of a light beam which is reflected to and fro once is indicated in the drawing for the purpose of explanation.

The embodiment shown in FIG. 3A is simple to realize, since in a conventional structure of an OLED 5, the electrode layer 52 is generally metallic and therefore also reflects light. An example of a suitable material for a metallic electrode layer of this type is aluminum or calcium. Moreover, the other layers of the OLED can be kept very thin and/or transparent, so that additional light absorption between the reflecting layers 7 and 52 is sufficiently low.

FIG. 3B shows a further embodiment of the invention, in which one of the electrode layers forms one of the light-reflecting layers. Unlike in the embodiment shown in FIG. 3A, however, in this case the transparent electrode layer 54 forms the light-reflecting layer. For this purpose, the electrode layer 54 in this case comprises two individual layers 541 and 542. Individual layer 541 is a TCO layer, in particular comprising indium tin oxide. Individual layer 542 comprises a thin metal layer and has a layer thickness which is suitable for acting as a semitransparent, light-reflecting layer, so that the light from the OLED 5 can be partially reflected to and fro between this individual layer 542 of the layer 54 and semitransparent layer 7.

FIG. 4A shows a variant of the display device shown in FIG. 1. In the exemplary embodiment shown in FIG. 4A, a structured luminous surface of the display device 1 is created by virtue of the fact that the light generated by the OLED luminous element 5 in the electroluminescent layer 53 is partially blended out. For this purpose, the display device 1 additionally has a mask 40 with light-absorbing or opaque regions 42 and transparent regions 44. The mask in this case forms the structured luminous surface of the display device 1. Instead of the transparent regions 44, the mask 40 may of course also have cutouts.

FIG. 4B shows a further variant of the display device illustrated in FIG. 1. In the embodiment shown in FIG. 4B, a structured luminous surface of the OLED 5 is created by virtue of the fact that one of the electrode layers is laterally structured. By way of example, in the embodiment shown in FIG. 4B, the transparent electrode layer 54 is structured. Alternatively, however, it is also possible for the electrode layer 54 to be correspondingly structured. The structuring is such that the layer 52 is interrupted or removed at regions 17 of the luminous surface which do not light up but is present at regions 16 which do light up.

In terms of its structure, the exemplary embodiment shown in FIG. 5 substantially corresponds to the exemplary embodiment illustrated in FIG. 1. Unlike in FIG. 1, the sides of the substrate 3 having the light-reflecting layers 7, 9, and therefore also the light-reflecting layers 7, 9 themselves, however, are not arranged plane-parallel, but rather are arranged obliquely with respect to one another. In this way, the impression of optical depth which has been explained with reference to FIG. 2 becomes visible even if the luminous surface of the display device 1 is viewed at right angles. Moreover, the oblique arrangement means that the distance between the light-reflecting layers 7, 9 changes along the observation side 10. This brings about an additional optical effect according to which the virtual images of the structures of the luminous surface are not arranged parallel to one another, but rather are each arranged at an angle to the adjacent images, so that the series of pictures appears “bent”.

FIG. 6 shows yet another variant of the embodiment of a display device 1 shown in FIG. 1. In this variant, the side of the substrate 3 having the light-reflecting layer 9, and therefore also the layer 9 itself, are curved. By way of example, this side of the substrate 9 is convex in form. In this arrangement, the virtual images of the luminous surface are magnified by the reflection at the concave inner side, which acts as a hollow mirror, of the light-reflecting layer 9.

It is also possible for both light-reflecting layers 7, 9 to be curved and/or for the curvature to take a different form, such as for example a concave shape, a wavy shape or any desired freeform shape.

To create a planar light emission surface, moreover, the light-reflecting layer 9 which faces outward is provided with a transparent covering 18. The covering also performs a further function by protecting the light-reflecting layer 9 from external effects, such as for example mechanical damage. A covering of this type may therefore also be expedient for the other exemplary embodiments, which have been shown with reference to FIGS. 1 to 5. The covering can be produced, for example, by coating with a transparent plastic or a transparent scratchproof coating, by sticking on a sheet or by applying a further transparent substrate.

FIG. 7 shows yet another embodiment of the invention. Unlike in the embodiments described above, the display device 1 illustrated in FIG. 7 has three light-reflecting layers 7, 9 and 11 arranged at a distance from one another. This display device is of similar structure to the embodiment shown in FIG. 1, with the provision of an additional substrate 4 having an outwardly facing light-reflecting layer 11, which is fitted onto the substrate 3 having the other two light-reflecting layers 7 and 9. The distance between the layers in each case results from the thickness of the substrates 3 and 4. Of course, it is also possible to attach further substrates of corresponding structure, so that the display device comprises more than three light-reflecting layers.

FIG. 8 shows a further modification to the embodiment of a display device 1 illustrated in FIG. 1. In this embodiment, the semitransparent light-reflecting layer 7 has been applied to the substrate 2 for the OLED 5. A second light-reflecting layer 9 is to be found on a further transparent substrate 3 which, as indicated by the double arrow, is arranged such that it can be displaced or positioned relative to the substrate 2 comprising the OLED and therefore also relative to the first light-reflecting layer 7. To realize a structure of this type, it is possible to provide a suitable means for holding the substrate 3 such that it can be displaced with respect to the substrate 2.

Apart from the embodiments of luminous elements according to the invention which have been explained with reference to FIGS. 3A and 3B, in which one of the light-reflecting layers forms part of the luminous element, there are in each case two or more light-reflecting layers arranged at a distance from the OLED 5 as luminous element. These embodiments are particularly advantageous if, even with thin layer thicknesses of the OLED, absorption which cannot be ignored still occurs in a functional layer of the OLED, such as in particular the electroluminescent layer, thereby attenuating the multiple reflections. This effect is also avoided in an embodiment, as shown in FIG. 3B, in which the light-reflecting layer is arranged on the light emission side of the OLED 5, so that a beam which is reflected at this layer does not pass back through the further functional layers of the OLED 5.

It will be clear to a person skilled in the art that the invention is not restricted to the embodiments described above, but rather can be varied in numerous ways. In particular, it is also possible for the features of the individual exemplary embodiments to be combined with one another.

### LIST OF DESIGNATIONS

1 Display device
2 Substrate for OLED 5
3, 4 Substrate for light-reflecting layers 7, 9, 11
5 OLED
7, 9, 11 Light-reflecting layers
10 Observation side of 1
12 Encapsulation glass
14 Region covered by 56
15 Region not covered by 56
16 Region of the luminous surface which lights up
17 Region of the luminous surface which does not light up
18 Covering of 9
21 First side of 2
22 Second side of 2
25 Eye of observer
30 Emission point in 53
31, 32 Virtual emission points
34, 35, 36 Light beams
40 Mask
42 Light-absorbing region of 40
44 Transparent region of 40
52 Electrode layer of 5
53 Electroluminescent layer of 5
54 Transparent electrode layer of 5
56 Structured insulation layer of 5
541 Conductive oxide layer of 54
542 Semitransparent metal layer of 54

1-22. (canceled)

23. A display device comprising:
a luminous element;
a laterally structured luminous surface having at least one region that is capable of illumination; and
a transparent substrate having a light-reflecting layer on each side of the transparent substrate at a first distance from one another, the transparent substrate being arranged so that one of the light-reflecting layers is opposite the laterally structured luminous surface, wherein light emitted by the laterally structured luminous surface is reflected along a beam path back and forth between the light-reflecting layers, and wherein at least one of the light-reflecting layers is semitransparent and at least one of the light-reflecting layers is arranged at a second distance from the luminous element.

24. The display device as claimed in claim 23, wherein at least one of the light-reflecting layers comprises an interference reflection layer.

25. The display device as claimed in claim 24, wherein the interference reflection layer comprises alternating layers with a high refractive index and a low refractive index, the alternating layers with the high refractive index comprising a first material selected from the group consisting of niobium oxide, tantalum oxide, and titanium oxide, and the alternating layers with the low refractive index comprising a second material selected from the group consisting of aluminum oxide, hafnium oxide, silicon oxide, and magnesium fluoride.

26. The display device as claimed in claim 23, wherein at least one of the light-reflecting layers comprises a metallic reflection layer.

27. The display device as claimed in claim 23, wherein at least one of the light-reflecting layers comprises a coating selected from the group consisting of a dip coating, a spin coating, a sputtered coating, a PVD coating, a CVD coating, a PECVD coating, and a PICVD coating.

28. The display device as claimed in claim 23, wherein the luminous element comprises an OLED.

29. The display device as claimed in claim 28, wherein the OLED comprises an electrode layer that forms one of the light-reflecting layers.

30. The display device as claimed in claim 29, wherein the electrode layer comprises transparent conductive oxide and a semitransparent thin metal layer.

31. The display device as claimed in claim 28, wherein the OLED comprises two electrode layers, the display device further comprising a laterally structured insulation layer that covers at least a region of one of the two electrode layers and is arranged between the two electrode layers.

32. The display device as claimed in claim 31, wherein at least one of the two electrode layers is laterally structured.

33. The display device as claimed in claim 23, further comprising a laterally structured mask.

34. The display device as claimed in claim 23, wherein the light-reflecting layers are arranged parallel to one another.

35. The display device as claimed in claim 23, wherein the light-reflecting layers are arranged obliquely with respect to one another.

36. The display device as claimed in claim 23, wherein at least one of the light-reflecting layers is curved.

37. The display device as claimed in claim 23, further comprising a partially absorbing material arranged in the beam path between the light-reflection layers.

38. The display device as claimed in claim 37, wherein the partially absorbing material comprises a colored material.

39. The display device as claimed in claim 23, wherein the at least one light-reflecting layers has a transmittance that varies spectrally in a wavelength region of the light emitted by the luminous element.

40. The display device as claimed in claim 23, wherein the at least one light-reflecting layers has a transmittance that varies spectrally as a function of an angle of incidence of the light emitted by the luminous element.

41. The display device as claimed in claim 23, wherein at least one of the light-reflecting layers is displaceably arranged relative to the other light-reflecting layer.

42. The display device as claimed in claim 41, wherein one of the light-reflecting layers is applied to the transparent substrate, and wherein the transparent substrate can be displaced or positioned with respect to the other of the light-reflecting layers.

43. The display device as claimed in claim 23, further comprising a third light-reflecting layer spaced apart from the light-reflecting layers.

44. The display device as claimed in claim 23, wherein the display device is configured for use as an information display selected from the group consisting of a motor vehicle, a telecommunications device, a mobile telephone, a domestic appliance, toy, an advertising, a warning or information board, an emblem, and a logo.
